(19) United States
(12) Patent Application Publication
(10) Pub. No.: US 2010/0244478 A1
(43) Pub. Date: Sep. 30, 2010

(54) VEHICLE CONSOLE WITH MOVABLE ARMREST

(75) Inventor: TODD L. DePUE, Brighton, MI (US)

Correspondence Address: INTERNATIONAL AUTOMOTIVE COMPONENTS GROUP, LLC;c/o MACMILLAN, SOBANSKI & TODD, LLC, ONE MARITIME PLAZA, FIFTH FLOOR, 720 WATER STREET, TOLEDO, OH, 43604, US

(73) Assignee: International Automotive Components Group North America, Inc., Dearborn, MI (US)

(21) Appl. No.: 12/414,196

(22) Filed: Mar. 30, 2009

(51) Int. Cl. B60N 3/00

(52) U.S. Cl. 296/24.43; 296/37.8

(57) ABSTRACT

This invention relates to a console that is adapted to be located between first and second seats in a vehicle, the console having a base including a guide surface; and an armrest supported on the guide surface for movement relative to the base in a first direction and a second direction that is different from the first direction.

### BACKGROUND OF THE INVENTION

This invention relates in general to a console for an automobile. The console is located between two vehicle seats, typically two front seats. The console includes one or more armrests for the occupants of those seats. The armrests of the console can be adjusted by the seat occupants in order to position the armrest based on the size of the occupant or to account for movement of the seat. The armrests can be configured to allow for movement in one or more of multiple directions, including forward and backward, left and right, up and down, as well as rotational movement about one or more axes.

### SUMMARY OF THE INVENTION

This invention relates to a console that is adapted to be located between first and second seats in a vehicle, the console having a base including a guide surface; and an armrest supported on the guide surface for movement relative to the base in a first direction and a second direction that is different from the first direction.

Various aspects of this invention will become apparent to those skilled in the art from the following detailed description of the preferred embodiments, when read in light of the accompanying drawings.

### BRIEF DESCRIPTION OF THE DRAWINGS

FIG. 1 is a perspective view of two vehicle seats and a first embodiment of a console with movable armrests.

FIG. 2 is a top plan view of the console of FIG. 1, with the movable armrests moved from their initial positions.

FIG. 3 is an exploded, perspective view of the console of FIG. 1.

FIG. 4 is a perspective view of a second embodiment of a console including a single movable armrest.

FIG. 5 is a perspective view of the console of FIG. 4, shown with the movable armrest moved lengthwise.

FIG. 6 is a perspective view of the console of FIG. 5, shown with the movable armrest moved pivotally.

FIG. 7 is an exploded perspective view of the console of FIG. 4.

FIG. 8 is a sectional elevational view of an attachment assembly suitable for use with the console of FIG. 4.

FIG. 9 is a top plan view of a third embodiment of a console including movable armrests, shown with one movable armrest moved from its initial position.

FIG. 10 is a front elevational view of the console of FIG. 9.

FIG. 11 is a front elevational view of the console of FIG. 9 with the armrest removed to show the attachment assembly.

### DETAILED DESCRIPTION OF THE PREFERRED EMBODIMENTS

Referring now to the drawings, there is illustrated in FIG. 1 a console, indicated generally at 10. The illustrated console 10 is suitable for use in the passenger compartment of a car or other vehicle. The illustrated console 10 is adapted to be located between first and second seats 12a and 12b in a vehicle. The console 10 is typically situated between a front driver seat 12a and a front passenger seat 12b. However, the console 10 can be situated in other locations, such as between rear passenger seats in a vehicle compartment.

The illustrated console 10 includes a base 14 and two movable armrests 16a and 16b. The movable armrests 16a and 16b are situated for use by occupants of the vehicle seats 12a and 12b. The illustrated movable armrests 16a and 16b include respective padded upper surfaces 17a and 17b for the comfort of the seat occupants, though this is not necessary. The illustrated movable armrests 16a and 16b are disposed for movement relative to the base 14. This allows occupants of the seats 12a and 12b to respectively move the movable armrests 16a and 16b to positions that are comfortable for the occupants. Movement of either of the movable armrest 16a and 16b may be desirable if the occupant is of smaller size than average, for instance, or if the seat 12a or 12b is adjusted to a different position.

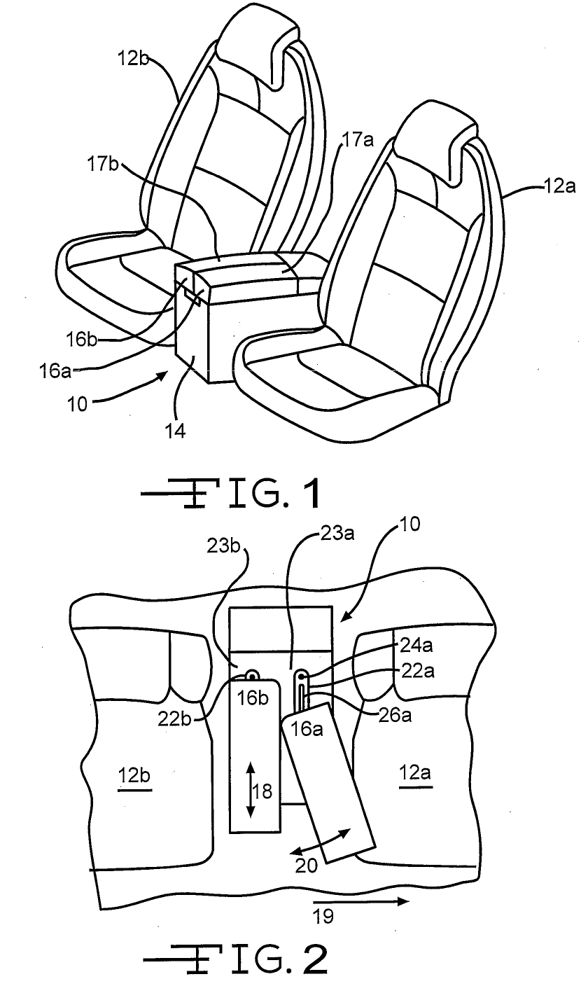

In FIG. 1, the two movable armrests 16a and 16b are illustrated in their respective initial positions. Referring to FIG. 2, the two movable armrests 16a and 16b are illustrated displaced from their initial positions into two different adjusted positions. The console 10 includes two guide surfaces 23a and 23b. In the illustrated embodiment, the two guide surfaces 23a and 23b are co-planar, although such is not required. The movable armrests 16a and 16b are supported on the guide surfaces 23a and 23b, and each movable armrest 16a and 16b is supported for sliding movement relative to the respective guide surface 23a and 23b.

The movable armrests 16a and 16b are capable of being moved in a first direction relative to the base 14, as indicated by arrow 18. In the illustrated embodiment, the first direction 18 is a longitudinal or lengthwise direction relative to the base 14. It should be appreciated that movement in the illustrated first direction 18 is fore-aft movement relative to a vehicle that the console 10 is mounted in. FIG. 2 illustrates the passenger-side movable armrest 16b is moved forward of its initial position.

The movable armrests 16a and 16b are also configured to be moved in a second direction relative to the base 14, as indicated by the arrow 19. The second direction 19 is different from the first direction 18. In the illustrated embodiment, the second direction 19 is a lateral direction relative to the base 14. It should be appreciated that movement in the illustrated second direction 19 is sidewise movement relative to the vehicle that the console 10 is mounted in, and that movement in the second direction 19 is toward one of the vehicle seats 12a and 12b. The illustrated movable armrests 16a and 16b are capable of movement in the second direction 19 by being pivoted or rotated relative to the base 14, as indicated by arrow 20. The illustrated rotational movement 20 is about an axis that is substantially perpendicular to the guide surface 23a. Referring to FIG. 2, the driver side movable armrest 16a is shown moved forward of its initial position and is also shown rotated toward the driver seat 12a. It should be appreciated that movable armrests 16a and 16b are configured so that the longitudinal movement indicated by arrow 18 is independent of the pivotal movement indicated by arrow 20. That is, each of the movable armrests 16a and 16b can be moved longitudinally from their initial positions and then rotated, similar to the position of movable armrest 16a in FIG. 2. However, each of the movable armrests 16a and 16b also could be rotated directly from its initial position without being moved longitudinally.

The illustrated movable armrests 16a and 16b are configured for independent movement. However, it should be appreciated that the movable armrests 16a and 16b can be configured for concurrent movement. That is, the armrests 16a and 16b can be configured so that when the movable armrest 16a is moved, the movable armrest 16b will also move. The illustrated movable armrests 16a and 16b are configured for manual movement between the initial position and adjusted positions. It should be appreciated that the movable armrests 16a and 16b can be configured for powered adjustment, such as by using electric motors or other suitable devices (not shown).

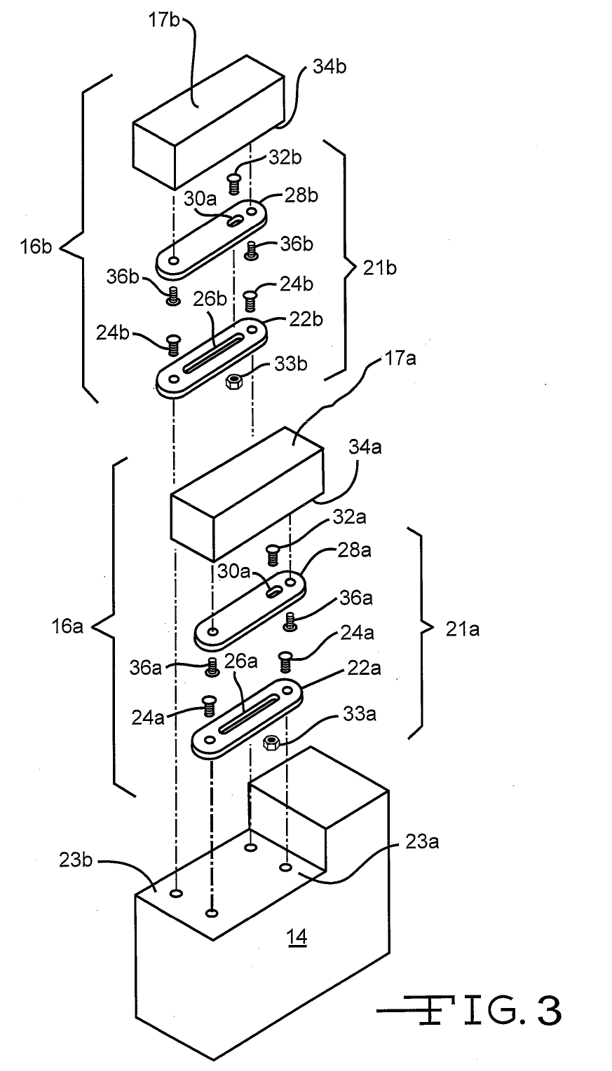

Referring to FIG. 3, an exploded, perspective view of the console 10 is shown. The base 14 is shown as a single unit, though it should be appreciated that the base 14 can be made of a number of separate pieces. Movable armrest 16a is connected to the base 14 by an attachment assembly indicated generally at 21a. The illustrated attachment assembly 21a movably connects the movable armrest 16a to the base 14.

The illustrated attachment assembly 21a includes a lower plate 22a that is attached to the upper surface of the base 14. The illustrated lower plate 22a is attached to the base 14 by two screws 24a. However, the lower plate 24a may alternatively be attached by adhesives, bolts, welding, or other suitable attachment structures. The illustrated lower plate 22a defines a channel 26a. An upper plate 28a. is disposed above the lower plate 22a. The illustrated upper plate 28a defines an opening 30a. The opening 30a is disposed so that a connecting structure can be inserted through the opening 30a and the channel 26a. In the illustrated embodiment, the connecting structure includes a bolt 32a and a nut 33a. However, any desired mechanism may be used for the connecting structure. The bolt 32a engages the upper plate 28a through the opening 30a and is fixed relative to the upper plate 28a. Therefore, the bolt 32a is able to slide in the channel 26a. The connecting structure allows the upper plate 28a to move relative to the lower plate 22a. The upper plate 28a can slide lengthwise, as the bolt 32a is able to slide in the channel 26a. The upper plate 28a can also pivot relative to the lower plate 22a. The bolt 32a allows the upper plate 28a to rotate relative to the lower plate 22a around the axis thereof. The upper plate 28a is attached to a lower surface 34a of the movable armrest 16a, such as by two screws 36a. However, the upper plate 28a may alternatively be attached by adhesives, bolts, welding, or other suitable attachment means. Alternatively, components of the attachment assembly 21a may be formed as integral parts of the base 14 or the movable armrest 34a. Although one attachment assembly 21a has been detailed, it should be appreciated that the movable armrest 16a can be attached to the base 14 by other suitable assemblies.

In the illustrated embodiment 10, the movable armrest 16b also includes an attachment assembly 21b. Attachment assembly 21b is attached to the base 14 to the side of the attachment assembly 21a. It should be appreciated that the movable armrest 16a is disposed for use by a person seated in the driver side seat, while the movable armrest 16b is disposed for use by someone in the passenger side seat. The illustrated attachment assembly 21b is similar in design to the previously-described attachment assembly 21a, and similar reference numbers are used in FIG. 2 to designate similar parts.

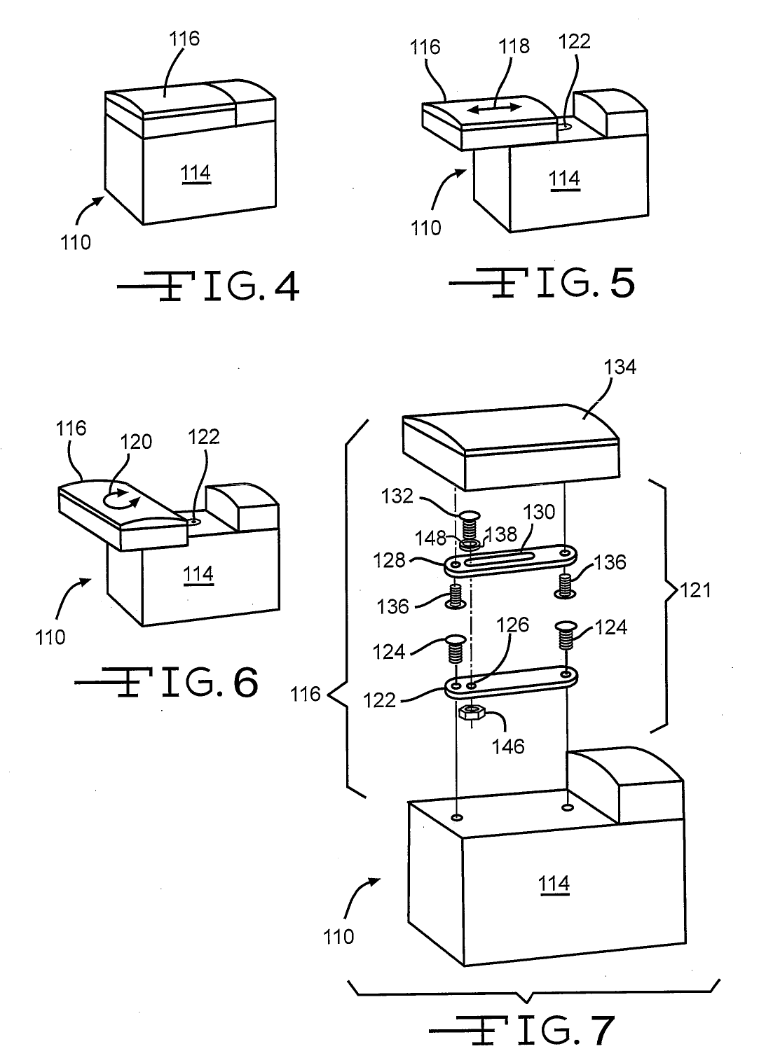

Referring to FIGS. 4 through 6, a second embodiment of a console 110 having a base 114 and a movable armrest 116 is shown. The second embodiment includes a single movable armrest 116, rather than the two movable armrests 16a and 16b of the first embodiment. FIG. 4 illustrates the movable armrest 116 in its initial position. Referring to FIG. 5, the movable armrest 116 is capable of being moved longitudinally or lengthwise relative to the base 114, as indicated by arrow 118. Referring to FIG. 6, the movable armrest 116 is also capable of rotational movement relative to the base 114, as indicated by arrow 120. The lengthwise movement 118 of the movable armrest 116 is independent of its rotational movement 120. That is, the movable armrest 116 can be rotated without being moved lengthwise and vice versa.

Referring to FIG. 7, an exploded, perspective view of the console 110 is shown. The console 110 includes an attachment assembly indicated generally at 121. Attachment assembly 121 includes a lower plate 122 which is attached to the base 114 by a pair of screws 124 or other conventional structures. The lower plate 122 defines an opening 126. An upper plate 128 is disposed above the lower plate 122 and is attached to a support member 134 by a pair of screws 136 or other conventional structures. The upper plate 128 defines a channel 130. A connecting structure 132 is disposed through the opening 126 and the channel 130. In the illustrated embodiment, the connecting structure includes a bolt 132 and a nut 146. However, any desired mechanism may be used for the connecting structure. The bolt 132 allows the upper plate 128 to move relative to lower plate 122. The illustrated upper plate 128 can slide lengthwise and pivot relative to the lower plate 122.

The connecting member is shown in greater detail in cross section in FIG. 8. The illustrated connecting member includes a cup 138. The cup 138 is a metal component, but can be made of other suitable materials. The cup 138 is disposed adjacent to the upper plate 128. The cup 138 is situated with a surface 140 in contact with the upper plate 128. The cup 138 includes a hole 142. The bolt 132 is disposed through the hole 142, the channel 130, and the opening 126. The illustrated bolt 132 is held in place by a washer 145 and the nut 146. The connecting member also includes a spring member 148. The spring member 148 is compressed between the cup 138 and a lip 150 on the bolt 132.

In operation of the illustrated attachment assembly 121, the connecting member 132 allows limited movement of the upper plate 128 relative to the lower plate 122. As previously described, the upper plate 128 is able to slide as indicated by arrow 118 (shown in FIG. 5) and rotate as indicated by arrow 120 (shown in FIG. 6). The spring member 148 provides a downward force (as viewed in FIG. 8) against the cup 138, which in turn presses the upper plate 128 against the lower plate 122 and increases the frictional force between the plates 122 and 128. The increase in frictional force helps to retain the movable armrest 116 in whatever adjusted position the user places it in.

The illustrated connecting member also allows for limited vertical movement of the upper plate 128 relative to the lower plate 122. The movable armrest 116 could be subject to an upwards force, either intentionally or accidentally. This could happen from someone attempting to pull up on the movable armrest 116 or from someone accidentally kicking the lower surface of the movable armrest 116 when it is in an adjusted position, for instance. In such a situation, the spring member 148 would further compress and allow for limited upward movement of the upper plate 128 relative to the lower plate 122. When the upward force is removed, the spring member 148 will push the upper plate 128 back into contact with the lower plate 122. By allowing this upward movement of the upper plate 128 relative to the lower plate 122, the movable armrest 116 is less likely to be damaged by being accidentally struck or pulled the wrong way.

It should be appreciated that while one attachment assembly 121 and connecting member has been described in detail, other suitable methods can be used to attach the movable armrest 116 to the base 114.

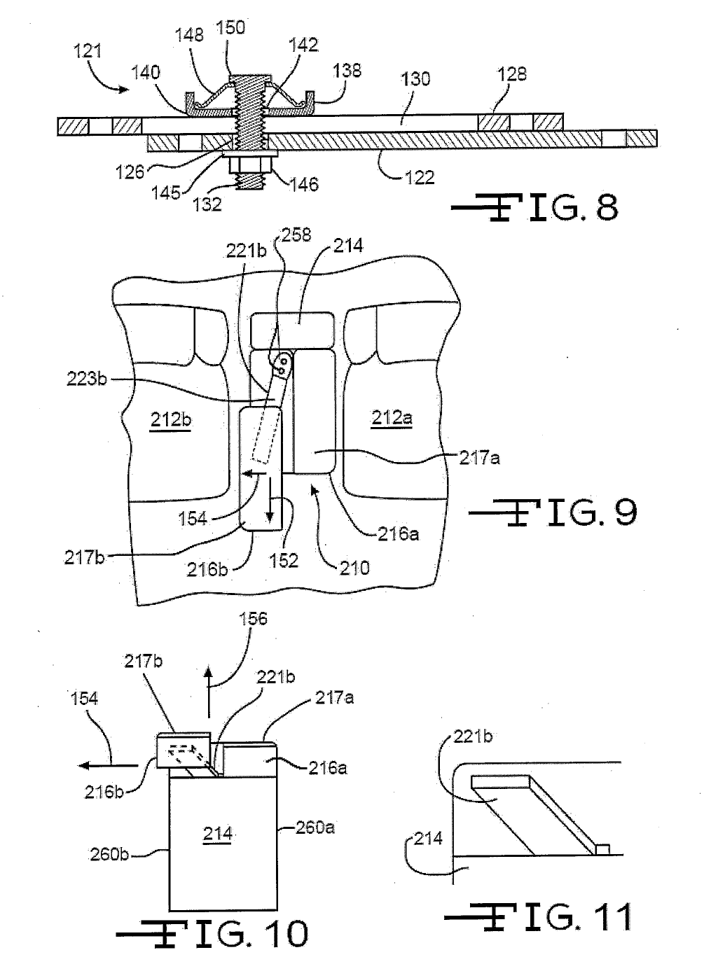

Referring now to FIG. 9, there is shown a third embodiment of a console 210 that is disposed between two seats 212a and 212b. The console 210 includes a base 214 and two movable armrests 216a and 216b. The movable armrests 216a and 216b have upper surfaces 217a and 217b, respectively. The movable armrest 216a is illustrated in an initial position, while the movable armrest 216b is illustrated in an adjusted position.

Movable armrest 216b is attached to base 214 by an attachment assembly 221b. The attachment assembly 221b is a track system that is configured to allow sliding movement of the movable armrest 216b relative to the base 214. The illustrated attachment assembly 221b is secured to the base 214 by screws 258. However, any other suitable attachment means can be used. The attachment assembly 221b includes a guide surface 223b. The attachment assembly 221b is configured to allow linear movement of movable armrest 216b.

As can be seen by comparison of FIGS. 8 and 9, the attachment assembly 221b is configured so that as movable armrest 216b is moved from its initial position to an adjusted position, the movable armrest 216b moves in three directions relative to the base 214. The movable armrest 216b is capable of being moved in a first direction relative to the base 214, as indicated by arrow 152, in a second direction relative to the base 214, as indicated by arrow 154, and in a third direction relative to the base 214, as indicated by arrow 156. In the illustrated embodiment, the first direction 152 is a longitudinal or forward direction, the second direction 154 is a lateral or sidewise direction, and the third direction 156 is a vertical or upwards direction. It should be appreciated that the terms “longitudinal,” “forward,” “lateral,” “sidewise,” “vertical” and “upwards” are in reference to the way the base 214 would generally be mounted in a vehicle.

The base 214 includes a first seat side 260a and a second seat side 260b. These correspond to the sides of the base 214 facing the driver seat 221a and the passenger seat 212b, respectively. The console 214 is configured so that the movable armrests 216a and 216b can be moved to adjusted positions so that they extend farther toward each seat 212a and 212b than they do in the initial positions. That is, the movable armrests 216a and 216b can extend farther toward both the first seat side 260a and the second seat side 260b in the adjusted position than they do in the initial position.

The illustrated movable armrest 216b moves along one path between its initial position and its adjusted positions. That is, the longitudinal, lateral, and vertical movements of the movable armrest 216b are not independent. When the movable armrest 216b is moved forward (in the direction of arrow 152), it simultaneously moves laterally (in the direction of arrow 154), and vertically (in the direction of arrow 156). It should be appreciated that the distance that the movable armrest 216b moves in each direction depends on the orientation of the attachment assembly 221b relative to the base 214. As shown, when the movable armrest 216b is moved along the path from its initial position to one of the adjusted positions, the amount of movement in the forward direction 152 is greater than the amount of movement in the lateral direction 154 and is greater than the amount of movement in the vertical direction 156.

It should be appreciated that the attachment assembly 221b could be configured to allow for movement of the movable armrest 216b in a way different from that illustrated. For example, the amount of relative movement in the forward, lateral and vertical directions could be different than what is illustrated. Or the attachment assembly 221b could be configured so that the movable armrest 216b can be moved from the initial position to the adjusted positions along a non-linear path. Alternatively, the attachment assembly 221b could be configured to allow rotational movement of the movable armrest 216b relative to the base 214. Rotational movement could be made possible about a hinge having a relatively vertical axis and located at the attachment point between the base 214 and the attachment assembly 221b. Or rotational movement could be about a hinge having a relatively vertical axis, located at the attachment point between the attachment assembly 221b and the movable armrest 216b. It should be appreciated that the attachment assembly 221b could be configured to allow for other types of rotational movement.

Additionally, movable armrest 216b could be configured so that the forward, sidewise and upwards movements are independent of each other.

It should be appreciate that movable armrest 216a includes an attachment assembly that is not shown in the figures. Movable armrest 216a is configured for movement comparable to that of movable armrest 216b. However, movable armrest 216a is configured so that the sidewise movement is toward the driver seat, rather than the toward the passenger seat.

As shown in FIG. 10, the upper surface 217b maintains its orientation relative to the base 214 when the movable armrest 216b is moved between its initial position and an adjusted position. That is, the upper surface 217b when the movable armrest 216b is in its initial position is substantially parallel to the upper surface 217b when the movable armrest 216b is in an adjusted position. It should be appreciated that this is not necessary, and the attachment assemblies 221a and 221b could be configured so that the movable armrests 216a and 216b have different orientations in the initial positions and in the adjusted positions.

The illustrated embodiments showing two movable armrests (for example, FIGS. 2 and 8) provide movable armrests that are capable of the same range of movement, mirrored along a centerline of the vehicle. It should be appreciated that this is not necessary, and the passenger side and driver side of a console could be provided with movable armrest configured for different types of movement. For instance, a console could include one movable armrest configured for movement like that shown for movable armrest 16b in FIG. 2, and a second movable armrest configured for movement like that shown for movable armrest 216a in FIGS. 8 and 9.

A console with a movable armrest could include conveniences for the driver and passengers of the vehicle, although these as not shown in any of the illustrated embodiments. These conveniences could include things such as storage compartments, change holders, cup holders, climate controls, and ventilation outlets. The conveniences could be located in the base or the movable armrest. Further, the console could include a storage space that is accessible when the movable armrest is moved to an adjusted position.

Each of the illustrated embodiments shows a console with a movable armrest. However, it should be appreciated that a movable armrest could be attached to some location of the vehicle other than a console. For example, a movable armrest could be attached to a vehicle door or a vehicle quarter panel.

The principle and mode of operation of this invention have been explained and illustrated in its preferred embodiments. However, it must be understood that this invention may be practiced otherwise than as specifically explained and illustrated without departing from its spirit or scope.

What is claimed is:

1. A console that is adapted to be located between first and second seats in a vehicle, the console comprising:
a base including a guide surface; and
an armrest supported on the guide surface for movement relative to the base in a first direction and a second direction that is different from the first direction.

2. The console of claim 1, further comprising
a channel on one of the armrest and the guide surface; and
a connecting member fixed relative to the other of the armrest and the guide surface and extending within the channel;
wherein the connecting member is movable relative to the channel.

3. The console of claim 2, wherein the armrest includes a plate and the channel is on the plate.

4. The console of claim 2, wherein the connecting member defines an axis and the armrest is supported for rotational movement relative to the base about the axis.

5. The console of claim 1, wherein the armrest is supported for rotational movement relative to the base about an axis substantially perpendicular to the guide surface.

6. The console of claim 5, wherein the guide surface is a first guide surface and the armrest is a first armrest, further comprising:
the base including a second guide surface; and
a second armrest supported on the second guide surface for movement relative to the base in the first direction and a third direction that is different from the first direction and the second direction, wherein the armrest is supported for rotational movement relative to the base about a second axis substantially perpendicular to the second guide surface.

7. The console of claim 6, further comprising:
a first channel on one of the first armrest and the first guide surface; a first connecting member fixed relative to the other of the first armrest and the first guide surface and extending within the first channel;
a second channel on one of the second armrest and the second guide surface; and a second connecting member fixed relative to the other of the second armrest and the second guide surface and extending within the second channel;
wherein the first connecting member is movable relative to the first channel; and the second connecting member is movable relative to the second channel.

8. The console of claim 1, wherein the guide surface is a first guide surface and the armrest is a first armrest, further comprising:
the base including a second guide surface; and
a second armrest supported on the second guide surface for movement relative to the base in the first direction and a third direction that is different from the first direction and the second direction.

9. The console of claim 8, wherein the first armrest is supported for movement along a first path and the second armrest is supported for movement along a second path.

10. The console of claim 1 wherein the base is mounted in a vehicle, and the first direction is fore-aft relative to the vehicle.

11. The console of claim 1, wherein the base is mounted in a vehicle, and the first direction is lateral relative to the vehicle.

12. The console of claim 1 wherein the base is mounted in a vehicle, the first direction is fore-aft relative to the vehicle and the second direction is lateral relative to the vehicle.

13. A console that is adapted to be located between first and second seats in a vehicle, the console comprising:
a base; and
an armrest having an upper surface, the armrest supported on the base for rotational movement relative to the base about an axis substantially perpendicular to the upper surface.

14. The console of claim 13, wherein the armrest is further supported for sliding movement relative to the base.

15. The console of claim 14, further comprising:
a channel on one of the armrest and the guide surface; and
a connecting member fixed relative to the other of the armrest and the guide surface and extending within the channel;
wherein the connecting member is movable relative to the channel and the connecting member defines the axis.

16. The console of claim 14 wherein the base is mounted in a vehicle and the sliding movement is fore-aft relative to the vehicle.

17. The console of claim 13, wherein the armrest is a first armrest, further comprising: a second armrest having a second upper surface, the second armrest supported on the base for rotational movement relative to the base about a second axis substantially perpendicular to the second upper surface.

18. The console of claim 17, wherein the first and second armrests are further supported for sliding movement relative to the base.

19. The console of claim 18, further comprising:
a first channel on one of the first armrest and the base; a first connecting member fixed relative to the other of the first armrest and the base and extending within the first channel;
a second channel on one of the second armrest and the base; and a second connecting member fixed relative to the other of the second armrest and the base and extending within the second channel;
wherein the first connecting member is movable relative to the first channel; and the second connecting member is movable relative to the second channel.

20. A console that is adapted to be located between first and second seats in a vehicle, the console comprising:
a base having a first seat side and a second seat side;
one or more armrests supported for movement relative to the base from an initial position;
wherein the one or more armrests can be moved so that they extend farther toward the first seat side and farther toward the second seat side than they do when they are in the initial position.
